(19) United States
(12) Patent Application Publication
(10) Pub. No.: US 2025/0322839 A1
(43) Pub. Date: Oct. 16, 2025

(54) SPEECH NOISE REDUCTION METHOD, APPARATUS, DEVICE AND COMPUTER-READABLE STORAGE MEDIUM

(71) Applicant: GOERTEK TECHNOLOGY CO., LTD, Qingdao, Shandong (CN)

(72) Inventor: Jingjing LI, Qingdao, Shandong (CN)

(21) Appl. No.: 18/870,545

(22) PCT Filed: Sep. 22, 2022
(86) PCT No.: PCT/CN2022/120525

§ 371 Date: Nov. 29, 2024

(30) Foreign Application Priority Data
Jun. 30, 2022 (CN) 202210763607.X

(51) Int. Cl. G10L 21/0232; G10L 25/30

(52) U.S. Cl. CPC G10L 21/0232; G10L 25/30

(57) ABSTRACT

Disclosed is speech noise reduction method including: acquiring first speech data, which is collected by means of a microphone, and acquiring second speech data, which is collected by means of a bone conduction sensor; and inputting speech data in a first frequency band of the first speech data and speech data in a second frequency band of the second speech data into a speech fusion noise reduction network and performing prediction, so as to obtain target noise reduced speech data, wherein the first frequency band is higher than the second frequency band, and the speech fusion noise reduction network is obtained by means of performing training in advance by performing training using noisy microphone speech data and noisy bone conduction speech data as input data, and using clean microphone speech data corresponding to the noisy microphone speech data as a training label.

This application claims priority to a Chinese patent application No. 202210763607.X, entitled “SPEECH NOISE REDUCTION METHOD, APPARATUS, DEVICE AND COMPUTER-READABLE STORAGE MEDIUM”, filed with the Chinese Patent Office on Jun. 30, 2022, the entire contents of which are incorporated by reference in this application.

### TECHNICAL FIELD

The present disclosure relates to the field of speech processing technology, and particularly, to a speech noise reduction method, apparatus, device and computer-readable storage medium.

### BACKGROUND

Speech noise reduction refers to the technology of extracting useful speech signals (or clean speech signals) from noisy speech signals as much as possible and suppressing or reducing noise interference when the speech signals are interfered with or even drowned by various background noises. Speech noise reduction technology is used in many scenarios, such as for call speech noise reduction. Among the current speech noise reduction technologies, there are schemes for noise reduction based on speech data collected by a single microphone or multiple microphones. However, although the speech data collected by the microphone covers a wide frequency domain range, it has almost no noise resistance. Therefore, the overall noise reduction effect of the speech noise reduction scheme based on speech data collected by the microphone cannot be further improved.

### SUMMARY

The present disclosure directs to provide a speech noise reduction method, apparatus, device and computer-readable storage medium, and to provide a solution for speech noise reduction based on speech data collected by a bone conduction sensor and speech data collected by a microphone, to improve the speech noise reduction effect.

To achieve the above object, the present disclosure provides a speech noise reduction method, wherein the speech noise reduction method includes:
acquiring first speech data collected by a microphone, and acquiring second speech data collected by a bone conduction sensor;
inputting speech data in a first frequency band of the first speech data and speech data in a second frequency band of the second speech data into a speech fusion noise reduction network and performing prediction, to obtain target noise reduced speech data,
wherein the first frequency band is higher than the second frequency band, the speech fusion noise reduction network is trained in advance by performing training using microphone noisy speech data and bone conduction noisy speech data as input data, and using microphone clean speech data corresponding to the microphone noisy speech data as a training label.

Optionally, the inputting the speech data in the first frequency band of the first speech data and the speech data in the second frequency band of the second speech data into the speech fusion noise reduction network and performing prediction, to obtain the target noise reduced speech data includes:
converting the first speech data of a single frame from time domain to frequency domain, to obtain first amplitudes and first phase angle values of a plurality of frequency point;
converting the second speech data of a single frame from time domain to frequency domain, to obtain second amplitudes and second phase angle values of a plurality of frequency point;
generating target input data according to the first amplitude and the first phase angle value corresponding to the plurality of frequency points in the first frequency band and the second amplitude and the second phase angle value corresponding to the plurality of frequency points in the second frequency band;
inputting the target input data into the speech fusion noise reduction network and performing prediction, to obtain third amplitudes and the third phase angle values of a plurality of frequency point;
performing frequency domain to time domain conversion based on the third amplitudes and the third phase angle values of the plurality of frequency point, to obtain a single frame of the target noise reduced speech data.

Optionally, the generating target input data according to the first amplitude and the first phase angle value corresponding to the plurality of frequency points in the first frequency band and the second amplitude and the second phase angle value corresponding to the plurality of frequency points in the second frequency band includes:
normalizing the first amplitude of the plurality of frequency points in the first frequency band and the second amplitude of the plurality of frequency points in the second frequency band, respectively, and then splicing them to obtain first channel data;
normalizing the first phase angle value of the plurality of frequency points in the first frequency band and the second phase angle value of the plurality of frequency points in the second frequency band, respectively, and then splicing them to obtain second channel data;
using the first channel data and the second channel data as the target input data with two channels.

Optionally, the inputting the speech data in the first frequency band of the first speech data and the speech data in the second frequency band of the second speech data into the speech fusion noise reduction network and performing prediction, to obtain the target noise reduced speech data includes:
inputting the speech data in the first frequency band of the first speech data and the speech data in the second frequency band of the second speech data into a convolution layer of the speech fusion noise reduction network for convolution processing, to obtain convolution output data;
inputting the convolution output data into a recurrent neural network layer of the speech fusion noise reduction network for processing, to obtain recurrent network output data; and
inputting the convolution output data and the recurrent network output data into an upsampling convolution layer of the speech fusion noise reduction network for upsampling convolution processing, to obtain the target noise reduced speech data based on a result of the upsampling convolution processing.

Optionally, before the inputting the speech data in the first frequency band of the first speech data and the speech data in the second frequency band of the second speech data into the speech fusion noise reduction network and performing prediction, to obtain the target noise reduced speech data, the method further includes:
in a round of training, inputting the speech data in the first frequency band of the microphone noisy speech data and the speech data in the second frequency band of the bone conduction noisy speech data into the speech fusion noise reduction network to be trained, and performing prediction, to obtain predicted noise reduced speech data;
calculating a first loss based on the speech data in the first frequency band of the predicted noise reduced speech data and the speech data in the first frequency band of the microphone clean speech data;
calculating a second loss based on the speech data in the second frequency band of the predicted noise reduced speech data and the speech data in the second frequency band of the microphone clean speech data;
performing a weighted summation of the first loss and the second loss to obtain a target loss, and updating the speech fusion noise reduction network to be trained according to the target loss, to use the updated speech fusion noise reduction network as a basis for the next round of training; and
after multiple rounds of training, using the updated speech fusion noise reduction network as the trained speech fusion noise reduction network.

Optionally, the performing the weighted summation of the first loss and the second loss, to obtain the target loss includes:
determining a round weight corresponding to a current round of training, wherein a larger number of training round corresponds to a larger weight corresponding to the second loss; and
weighted summing the first loss and the second loss according to the round weight corresponding to the current round, to obtain the target loss.

Optionally, before the inputting the speech data in the first frequency band of the first speech data and the speech data in the second frequency band of the second speech data into the speech fusion noise reduction network and performing prediction, to obtain the target noise reduced speech data, the method further includes:
acquiring first background noise data collected by the microphone in a background noise environment and first clean speech data collected by the microphone in a noise isolation environment, and acquiring second background noise data collected by a bone conduction sensor in the background noise environment and second clean speech data collected by the bone conduction sensor in the noise isolation environment;
adding the first noise data to the first clean speech data according to a preset signal-to-noise ratio, to obtain the microphone noisy speech data; and
adding the second noise data to the second clean speech data according to the noise weight in the microphone noisy speech data, to obtain the bone conduction noisy speech data.

To achieve the above object, the present disclosure further provides a speech noise reduction apparatus, wherein the speech noise reduction apparatus includes:
an acquisition module, configured to acquire first speech data collected by a microphone and second speech data collected by a bone conduction sensor;
a prediction module, configured to input speech data of first frequency band of the first speech data and speech data in the second frequency band of the second speech data into the speech fusion noise reduction network and performing prediction, to obtain target noise reduced speech data,
wherein the first frequency band is higher than the second frequency band, the speech fusion noise reduction network is trained in advance by using microphone noisy speech data and bone conduction noisy speech data as input data, and performing training using microphone clean speech data corresponding to the microphone noisy speech data as a training label.

To achieve the above object, the present disclosure further provides a speech noise reduction device, wherein the speech noise reduction device includes: a memory, a processor, and a speech noise reduction program stored in the memory and executable on the processor, wherein when executed by the processor, the speech noise reduction program implements steps of the speech noise reduction method as described above.

In addition, to achieve the above object, the present disclosure further provides a computer-readable storage medium, wherein a speech noise reduction program is stored on the computer-readable storage medium, and when the speech noise reduction program is executed by a processor, steps of the speech noise reduction method as described above are implemented.

In the present disclosure, by performing training using microphone noisy speech data and bone conduction noisy speech data as input data, using microphone clean speech data corresponding to the microphone noisy speech data as a training label, a speech fusion noise reduction network is trained, and then after obtaining the first speech data collected by the microphone and the second speech data collected by the bone conduction sensor, the speech data in the first frequency band of the first speech data and the speech data in the second frequency band of the second speech data are input into the trained speech fusion noise reduction network and performing prediction, to obtain target noise reduced speech data. Since the speech fusion noise reduction network learns through training to predict speech data with good and clean speech effects based on the low-frequency part with less noise in the bone conduction noisy speech data and the high-frequency part with good speech effects in the microphone noisy speech data, the predicted target noise reduced speech data sounds natural and also shows a better noise reduction effect, that is, compared with noise reduction based only on the speech data collected by the microphone, the speech noise reduction scheme of the present disclosure further improves the speech noise reduction effect.

### BRIEF DESCRIPTION OF DRAWINGS

FIG. 1 is a schematic diagram of the structure of a hardware environment in which an embodiment of the present disclosure operates.

FIG. 2 is a flow chart of a first embodiment of a method for reducing speech noise according to the present disclosure.

FIG. 3 is a schematic diagram of a speech fusion noise reduction network structure in an embodiment of the present disclosure.

FIG. 4 is a schematic block diagram of a preferred embodiment of a speech noise reduction apparatus of the present disclosure.

The realization of the purpose, functional features and advantages of the present disclosure will be further explained in conjunction with embodiments and with reference to the accompanying drawings.

### DETAILED DESCRIPTIONS

It should be noted that the specific embodiments described herein are only configured to explain the present disclosure, and are not intended to limit the scope of the present disclosure.

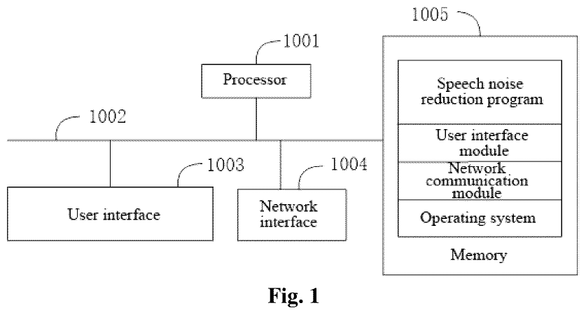

As shown in FIG. 1, FIG. 1 is a schematic diagram of the device structure of the hardware environment in which the embodiment of the present disclosure operates.

It should be noted that the speech noise reduction device in the embodiments of the present disclosure may be earphones, a smart phone, a personal computer, a server or other device, and is not specifically limited herein.

As shown in FIG. 1, the speech noise reduction device may include: a processor 1001, such as a CPU, a network interface 1004, a user interface 1003, a memory 1005, and a communication bus 1002. Among them, the communication bus 1002 is configured to realize the connection and communication between these components. The user interface 1003 may include a displayer, an input unit such as a keyboard, and the optional user interface 1003 may also include a standard wired interface and a wireless interface. The network interface 1004 may optionally include a standard wired interface and a wireless interface (such as a WI-FI interface). The memory 1005 may be a high-speed RAM memory, or a non-transitory memory (non-volatile memory), such as a disk memory. The memory 1005 may also be a storage device independent of the above-mentioned processor 1001.

Those skilled in the art will appreciate that the device structure shown in FIG. 1 is not intended to limit the speech noise reduction device according to the present disclosure, and may include more or fewer components than shown in the FIG. 1, or a combination of some components, or a different arrangement of these components.

As shown in FIG. 1, the memory 1005 as a computer storage medium may include an operating system, a network communication module, a user interface module, and a speech noise reduction program. The operating system is a program that manages and controls the hardware and software resources of the device, and supports the operation of the speech noise reduction program and other software or programs. In the device shown in FIG. 1, the user interface 1003 is mainly used for data communication with the user; the network interface 1004 is mainly configured to establish a communication connection with the server; and the processor 1001 can be configured to call the speech noise reduction program stored in the memory 1005 and perform the following operations:
acquiring first speech data collected by a microphone, and acquiring second speech data collected by a bone conduction sensor;
inputting speech data in a first frequency band of the first speech data and speech data in a second frequency band of the second speech data into a speech fusion noise reduction network and performing prediction, to obtain target noise reduced speech data,
wherein the first frequency band is higher than the second frequency band, the speech fusion noise reduction network is trained in advance by performing training using microphone noisy speech data and bone conduction noisy speech data as input data, and using microphone clean speech data corresponding to the microphone noisy speech data as a training label.

Furthermore, the inputting the speech data in the first frequency band of the first speech data and the speech data in the second frequency band of the second speech data into the speech fusion noise reduction network and performing prediction, to obtain the target noise reduced speech data includes:
converting the first speech data of a single frame from time domain to frequency domain, to obtain first amplitudes and first phase angle values of the plurality of frequency point;
converting the second speech data of a single frame from time domain to frequency domain, to obtain second amplitudes and second phase angle values of the plurality of frequency point;
generating target input data according to the first amplitude and the first phase angle value corresponding to the plurality of frequency points in the first frequency band and the second amplitude and the second phase angle value corresponding to the plurality of frequency points in the second frequency band;
inputting the target input data into the speech fusion noise reduction network and performing prediction, to obtain third amplitudes and the third phase angle values of the plurality of frequency point;
performing frequency domain to time domain conversion based on the third amplitudes and the third phase angle values of the plurality of frequency point, to obtain a single frame of the target noise reduced speech data.

Furthermore, the generating target input data according to the first amplitude and the first phase angle value corresponding to the plurality of frequency points in the first frequency band and the second amplitude and the second phase angle value corresponding to the plurality of frequency points in the second frequency band includes:
normalizing the first amplitude of the plurality of frequency points in the first frequency band and the second amplitude of the plurality of frequency points in the second frequency band, respectively, and then splicing them to obtain first channel data;
normalizing the first phase angle value of the plurality of frequency points in the first frequency band and the second phase angle value of the plurality of frequency points in the second frequency band, respectively, and then splicing them to obtain second channel data; and
using the first channel data and the second channel data as the target input data with two channels.

Furthermore, the inputting the speech data in the first frequency band of the first speech data and the speech data in the second frequency band of the second speech data into the speech fusion noise reduction network and performing prediction, to obtain the target noise reduced speech data includes:
inputting the speech data in the first frequency band of the first speech data and the speech data in the second frequency band of the second speech data into a convolution layer of the speech fusion noise reduction network for convolution processing, to obtain convolution output data;
inputting the convolution output data into a recurrent neural network layer of the speech fusion noise reduction network for processing, to obtain recurrent network output data; and
inputting the convolution output data and the recurrent network output data into an upsampling convolution layer of the speech fusion noise reduction network for upsampling convolution processing, to obtain the target noise reduced speech data based on a result of the upsampling convolution processing.

Furthermore, before the inputting the speech data in the first frequency band of the first speech data and the speech data in the second frequency band of the second speech data into the speech fusion noise reduction network and performing prediction, to obtain the target noise reduced speech data, the processor 1001 can be configured to call the speech noise reduction program stored in the memory 1005 and perform the following operations:
in a round of training, inputting the speech data in the first frequency band of the microphone noisy speech data and the speech data in the second frequency band of the bone conduction noisy speech data into the speech fusion noise reduction network to be trained, and performing prediction, to obtain predicted noise reduced speech data;
calculating a first loss based on the speech data in the first frequency band of the predicted noise reduced speech data and the speech data in the first frequency band of the microphone clean speech data;
calculating a second loss based on the speech data in the second frequency band of the predicted noise reduced speech data and the speech data in the second frequency band of the microphone clean speech data;
performing the weighted summation of the first loss and the second loss to obtain a target loss, and updating the speech fusion noise reduction network to be trained according to the target loss, to use the updated speech fusion noise reduction network as a basis for the next round of training; and
after multiple rounds of training, using the updated speech fusion noise reduction network as the trained speech fusion noise reduction network.

Furthermore, the performing the weighted summation of the first loss and the second loss, to obtain the target loss includes:
determining a round weight corresponding to a current round of training, wherein a larger number of training round corresponds to a larger weight corresponding to the second loss; and
weighted summing the first loss and the second loss according to the round weight corresponding to the current round, to obtain the target loss.

Furthermore, before the inputting the speech data in the first frequency band of the first speech data and the speech data in the second frequency band of the second speech data into the speech fusion noise reduction network and performing prediction, to obtain the target noise reduced speech data, the processor 1001 can be configured to call the speech noise reduction program stored in the memory 1005 and perform the following operations:
acquiring first background noise data collected by the microphone in a background noise environment and first clean speech data collected by the microphone in a noise isolation environment, and acquiring second background noise data collected by a bone conduction sensor in the background noise environment and second clean speech data collected by the bone conduction sensor in the noise isolation environment;
adding the first noise data to the first clean speech data according to a preset signal-to-noise ratio, to obtain the microphone noisy speech data; and
adding the second noise data to the second clean speech data according to the noise weight in the microphone noisy speech data, to obtain the bone conduction noisy speech data.

Based on the above structure, various embodiments of the speech noise reduction method are proposed.

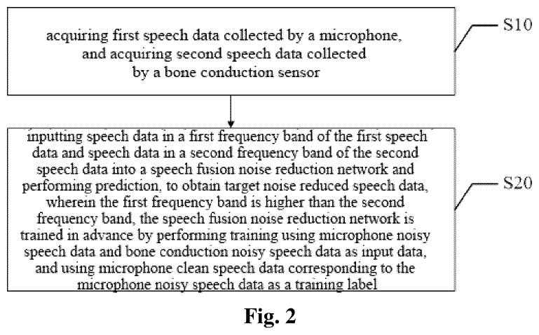

Refer to FIG. 2, which is a flow chart of a first embodiment of a speech noise reduction method according to the present disclosure.

The embodiment of the present disclosure provides an embodiment of the speech noise reduction method. It should be noted that although the logical order is shown in the flowchart, in some cases, the steps shown or described can be performed in a different order than here. In this embodiment, the execution subject of the speech noise reduction method can be earphones, a personal computer, a smart phone and other devices, which is not limited in this embodiment. For the convenience of description, the embodiments on the personal computer, the smart phone and other devices are omitted. In this embodiment, the speech noise reduction method includes:

Step S10, acquiring first speech data collected by a microphone, and acquiring second speech data collected by a bone conduction sensor;

In this embodiment, the speech data collected by the bone conduction sensor is configured to assist the voice noise reduction of the speech data collected by the microphone. For the sake of distinction, the speech data collected by the microphone is referred to as the first speech data, and the speech data collected by the bone conduction sensor is referred to as the second speech data. It can be understood that the first speech data and the second speech data are collected synchronously in the same environment. In a specific application scenario, the microphone and the bone conduction sensor can be set in the product for collecting speech data, such as being set in the earphones, and the specific setting position is designed as needed, for example, the bone conduction sensor is generally set in a place in contact with the human skull. In a specific implementation, the first speech data and the second speech data can be real-time collected speech data or non-real-time speech data. Different implementation methods can be selected according to different real-time requirements for voice noise reduction in the application scenario. For example, for call voice noise reduction, the speech data collected by the microphone and the bone conduction sensor can be respectively framed in real time, and the single-frame first speech data and the single-frame second speech data are used as objects for real-time noise reduction processing based on the voice noise reduction scheme in this embodiment.

Step S20, inputting the speech data in the first frequency band of the first speech data and the speech data in the second frequency band of the second speech data into the speech fusion noise reduction network and performing prediction, to obtain target noise reduced speech data.

In this embodiment, a speech fusion noise reduction network is obtained by training trained in advance. The training process is to use microphone noisy speech data and bone conduction noisy speech data as input data of the speech fusion noise reduction network, process the input data based on the speech fusion noise reduction network to obtain predicted (or estimated) speech data, and use the microphone clean speech data corresponding to the microphone noisy speech data as a training label, and use a supervised training method for training. That is, the speech data predicted by the speech fusion noise reduction network is supervised by the training label to continuously update the network parameters in the speech fusion noise reduction network, so that the speech data predicted by the speech fusion noise reduction network after the parameters are updated is closer to the microphone clean speech data, and then train to obtain a speech fusion noise reduction network that can predict the clean speech data based on the noisy speech data collected by the microphone and the noisy speech data collected by the bone conduction sensor.

Here, the specific network layer structure of the speech fusion noise reduction network is not limited in this embodiment. For example, it can be implemented by using network structures such as convolutional neural networks or recurrent neural networks. In a specific implementation, the microphone noisy speech data, bone conduction noisy speech data and microphone clean speech data used in training can be obtained by playing the same speech in an experimental environment, and then collecting them by a microphone and a bone conduction sensor, while the microphone clean speech data can be obtained even in a noise isolation environment. The number of samples used for training can be set as needed and is not limited in this embodiment. It can be understood that one training sample includes one microphone noisy speech data, one bone conduction noisy speech data and one microphone clean speech data.

It should be noted that the data collected by the microphone is relatively complete in frequency domain, but hardly has any anti-noise ability, while the speech data collected by the bone conduction sensor is mainly concentrated in the low-frequency part. Although the high-frequency information of the data is lost and the voice does not sound good, its anti-noise ability is superior and can block many types of noise. Therefore, in this embodiment, by taking advantage of the microphone and the bone conduction sensor, when the microphone noisy speech data and the bone conduction noisy speech data are input into the speech fusion noise reduction network, the speech data in the first frequency band of the microphone noisy speech data and the speech data in the second frequency band of the bone conduction noisy speech data can be input into the speech fusion noise reduction network, and the first frequency band is set as be higher than the second frequency band, so that through training, the speech fusion noise reduction network can learn how to use the low-frequency part with less noise in the bone conduction noisy speech data and the high-frequency part with good voice effect in the microphone noisy speech data to predict the speech data with good and clean voice effect. Here, good voice effect means that the user sounds more natural.

Here, a frequency band refers to one frequency range, and one frequency range includes multiple frequency points. The first frequency band is higher than the second frequency band, which means that the minimum frequency point in the first frequency band is higher than the maximum frequency point in the second frequency band. The boundary frequency point in the first frequency band and the second frequency band can be set as needed, and is not limited in this embodiment. For example, it can be set as 1 KHZ, then the first frequency band ofcludes all frequency points above 1 KHZ, and the second frequency band ofcludes all frequency points below 1 KHZ (including 1 KHZ).

After obtaining the first speech data to be noise reduced and the second speech data for auxiliary noise reduction, the speech data in the first frequency band of the first speech data is extracted, and the speech data in the second frequency band of the second speech data is extracted, and the two types of speech data extracted are input into the trained speech fusion noise reduction network, and the input speech data is processed through each network layer of the speech fusion noise reduction network to obtain the noise reduced speech data (hereinafter referred to as the target noise reduced speech data for differentiation). It can be understood that since the speech data in the first frequency band of the first speech data and the speech data in the second frequency band of the second speech data are input into the trained speech fusion noise reduction network and performing prediction, to obtain the target noise reduced speech data, the obtained target noise reduced speech data is speech data with good voice effect and clean.

In this embodiment, by using microphone noisy speech data and bone conduction noisy speech data as input data and using microphone clean speech data corresponding to the microphone noisy speech data as a training label, a speech fusion noise reduction network is trained, and then after obtaining the first speech data collected by the microphone and the second speech data collected by the bone conduction sensor, the speech data in the first frequency band of the first speech data and the speech data in the second frequency band of the second speech data are input into the trained speech fusion noise reduction network and performing prediction, to obtain target noise reduced speech data. Since the speech fusion noise reduction network learns through training to predict speech data with good and clean speech effects based on the low-frequency part with less noise in the bone conduction noisy speech data and the high-frequency part with good speech effects in the microphone noisy speech data, the predicted target noise reduced speech data sounds natural and also shows a better noise reduction effect, that is, compared with noise reduction based only on the speech data collected by the microphone, the speech noise reduction scheme of this embodiment further improves the speech noise reduction effect.

Furthermore, in an embodiment, before step S20, the method further includes:

Step a), acquiring first background noise data collected by the microphone in a background noise environment and first clean speech data collected by the microphone in a noise-isolated environment, and acquiring second background noise data collected by a bone conduction sensor in a background noise environment and second clean speech data collected by the bone conduction sensor in a noise-isolated environment.

In this embodiment, to improve the noise reduction effect of the noise reduced speech data predicted by the speech fusion noise reduction network based on speech data with different signal-to-noise ratios, clean speech data and noise data are collected and mixed according to different signal-to-noise ratios to obtain noisy speech data for training.

Specifically, background noise data (hereinafter referred to as the first background noise data) can be collected by a microphone in a background noise environment, and clean speech data (hereinafter referred to as the first clean speech data) can be collected by a microphone in a noise isolation environment. The background noise environment can be an environment in which noise is played by a playback device, and the played noise can be noise selected as needed to simulate various noises that may occur in real scenes; the noise isolation environment can be an environment with no noise or very little noise, so the speech data collected in the noise isolation environment can be considered as speech data without noise, and therefore can be called clean speech data. When the first background noise data is collected by a microphone in a background noise environment, the background noise data (hereinafter referred to as the second background noise data) can be collected by a bone conduction sensor at the same time, and when the first clean speech data is collected by a microphone in a noise isolation environment, the speech data (hereinafter referred to as the second clean speech data) can be collected by a bone conduction sensor at the same time.

In a specific implementation, by playing different noises, multiple sets of noise data can be collected, each set of noise data includes a first background noise data and a second background noise data. By playing different voices, multiple sets of clean speech data can be collected, each set of clean speech data includes a first clean speech data and a second clean speech data.

Step b), adding the first noise data to the first clean speech data according to a preset signal-to-noise ratio, to obtain microphone noisy speech data; and

Step c): adding the second noise data to the second clean speech data according to the noise weight in the microphone noisy speech data, to obtain the bone conduction noisy speech data.

By adding the first noise data in a set of noise data to the first clean speech data in a set of clean speech data according to a preset signal-to-noise ratio, microphone noisy speech data in a sample can be obtained, and the first clean speech data can be used as the microphone clean speech data in the sample, that is, as the training label in the sample. The preset signal-to-noise ratio can be set as needed.

According to the noise weight in the microphone noisy speech data in the sample, the second noise data in the set of noise data is added to the second clean speech data in the set of clean speech data according to the noise weight, to obtain the bone conduction noisy speech data in the sample. The noise weight may be the ratio of the amplitude of the noise signal to the amplitude of the speech signal at the same time.

It is understandable that by adding a set of noise data to a set of clean speech data at different signal-to-noise ratios, multiple samples with different signal-to-noise ratios can be obtained. In this embodiment, by mixing the collected clean speech data with the noise data at different signal-to-noise ratios to obtain noisy speech data for training the speech fusion noise reduction network, the noise reduction effect of the noise reduced speech data predicted by the speech fusion noise reduction network based on speech data with different signal-to-noise ratios can be improved, and the number of training samples can also be expanded to reduce the labor cost of collecting training samples.

Further, based on the above first embodiment, a second embodiment of the speech noise reduction method of the present disclosure is proposed. In this embodiment, step S20 includes:

Step S201, converting a single frame of first speech data from time domain to frequency domain, to obtain first amplitudes and first phase angle values of a plurality of frequency point.

In this embodiment, the single frame of the first speech data may be converted from time domain to frequency domain, to obtain the amplitude (hereinafter referred to as the first amplitude for differentiation) and the phase angle value (hereinafter referred to as the first phase angle value for differentiation) of the respective frequency points. The conversion from time domain to frequency domain may be achieved by Fourier transform. The complex number of the respective frequency points may be first converted, and then the amplitude and the phase angle value may be calculated based on the complex number.

Step S202, converting the single frame of second speech data from time domain to frequency domain, to obtain second amplitudes and second phase angle values of a plurality of frequency point.

The single frame of the second speech data is converted from time domain to frequency domain, to obtain the amplitudes (hereinafter referred to as the second amplitudes for differentiation) and the phase angle values (hereinafter referred to as the second phase angle values for differentiation) of the respective frequency points. The conversion from time domain to frequency domain can be realized by Fourier transform. The complex number of the respective frequency points can be converted first, and then the amplitude and phase angle value can be calculated based on the complex number.

Step S203, generating target input data according to the first amplitude and the first phase angle value corresponding to the plurality of frequency points in the first frequency band and the second amplitude and the second phase angle value corresponding to the plurality of frequency points in the second frequency band.

After the first speech data is converted to obtain the first amplitudes and the first phase angle values of the respective frequency points, the first amplitude and the first phase angle value of the plurality of frequency points in the first frequency band can be extracted therefrom. For example, the first speech data is converted to obtain the first amplitudes and the first phase angle values of 120 frequency points, and the first frequency band ofcludes the last 113 frequency points of the 120 frequency points, so the first amplitudes and the first phase angle values of the last 113 frequency points are extracted.

After the second speech data is converted to obtain the second amplitudes and the second phase angle values of the respective frequency points, the second amplitude and the second phase angle value of the plurality of frequency points in the second frequency band can be extracted therefrom. For example, the second speech data is converted to obtain the second amplitudes and the second phase angle values of 120 frequency points, and the second frequency band ofcludes the first 7 frequency points of the 120 frequency points, so the second amplitudes and the second phase angle values of the first 7 frequency points are extracted.

According to the first amplitude and the first phase angle value corresponding to the plurality of frequency points in the first frequency band and the second amplitude and the second phase angle value corresponding to the plurality of frequency points in the second frequency band, input data (hereinafter referred to as target input data) for being input into the speech fusion noise reduction network is generated. According to the different data structures of the designed speech fusion noise reduction network input data, the method of generating the target input data is also different, that is, it is necessary to generate target input data that conforms to the input data structure of the speech fusion noise reduction network.

Step S204, inputting the target input data into the speech fusion noise reduction network and performing prediction, to obtain the third amplitudes and the third phase angle values of the respective frequency points.

The target input data is input into the speech fusion noise reduction network and performing prediction, and the amplitude (hereinafter referred to as the third amplitude for differentiation) and phase angle value (hereinafter referred to as the third phase angle for differentiation) of the respective frequency points can be obtained. For example, the third amplitudes and third phase angle values of 120 frequency points can be obtained.

Step S205: performing frequency domain to time domain conversion based on the third amplitudes and the third phase angle values of a plurality of frequency point, to obtain a single frame of the target noise reduced speech data.

The third amplitudes and the third phase angle values of the respective frequency points are converted from frequency domain to time domain, to obtain a single frame of the target noise reduced speech data. Here, the conversion from frequency domain to time domain can be achieved by an inverse Fourier transform. In a specific implementation, when the speech fusion noise reduction network is designed to output a value in the range of 0 to 1, the third amplitude of the plurality of frequency points in the first frequency band can be denormalized and the third amplitude of the plurality of frequency points in the second frequency band can be denormalized to obtain the fourth amplitudes of the plurality of frequency point, the third phase angle values of the plurality of frequency points in the first frequency band can be denormalized and the third phase angle value of the plurality of frequency points in the second frequency band can be denormalized to obtain the fourth phase angle values of the respective frequency points, and then frequency domain is converted from time domain based on the fourth amplitude and the fourth phase angle value of the respective frequency points, to obtain a single frame of the target noise reduced speech data. Specifically, when the noise-reduced speech data is obtained by converting frequency domain to time domain based on the amplitude and phase angle value of the plurality of frequency points, the complex number of the frequency point can be first calculated based on the amplitude and phase angle value of the single frequency point, and then an inverse Fourier transform can be performed based on the complex number of the plurality of frequency points, to obtain a single frame of noise-reduced speech data.

In this embodiment, the amplitude and phase angle values of the plurality of frequency points in the first frequency band of the first speech data, as well as the amplitude and phase angle values of the plurality of frequency points in the second frequency band of the second speech data, are input into the speech fusion noise reduction network and performing prediction, so that the speech fusion noise reduction network can not only predict accurate speech data based on the amplitude of the plurality of frequency points, but also predict speech data that sounds more natural to the user based on the phase angle value of the plurality of frequency points, thereby further improving the speech noise reduction effect.

Further, in an embodiment, step S203 includes:

Step S2031, normalizing the first amplitude of the plurality of frequency points in the first frequency band and the second amplitude of the plurality of frequency points in the second frequency band, respectively, and then splicing them to obtain first channel data.

In this embodiment, the first amplitude of the plurality of frequency points in the first frequency band can be normalized, the second amplitude of the plurality of frequency points in the second frequency band can be normalized, and then the normalized first amplitude of the plurality of frequency points in the first frequency band and the normalized second amplitude of the plurality of frequency points in the second frequency band can be spliced to obtain input data of one channel (hereinafter referred to as first channel data). The splicing can be specifically vector splicing. For example, the first frequency band ofcludes 113 frequency points and the second frequency band ofcludes 7 frequency points, then the amplitudes of the 7 frequency points in the second frequency band and the amplitudes of the 113 frequency points in the first frequency band can be vector spliced to obtain a vector including 120 amplitudes.

Step S2032, normalizing the first phase angle value of the plurality of frequency points in the first frequency band and the second phase angle value of the plurality of frequency points in the second frequency band, respectively, and then splicing them to obtain second channel data.

The first phase angle value of the plurality of frequency points in the first frequency band can be normalized, the second phase angle value of the plurality of frequency points in the second frequency band can be normalized, and then the normalized first phase angle value of the plurality of frequency points in the first frequency band and the normalized second phase angle value of the plurality of frequency points in the second frequency band can be spliced to obtain input data of one channel (hereinafter referred to as second channel data). The splicing can be specifically vector splicing. For example, the first frequency band ofcludes 113 frequency points and the second frequency band ofcludes 7 frequency points. The phase angle values of the 7 frequency points in the second frequency band and the phase angle values of the 113 frequency points in the first frequency band are vector spliced to obtain a vector including 120 phase angle values.

Step S2033: using the first channel data and the second channel data as target input data with two channels.

The first channel data and the second channel data are used as target input data with two channels.

Furthermore, in an embodiment, during the training of the speech fusion noise reduction network, a single frame of microphone noisy speech data can also be converted from time domain to frequency domain, to obtain the fifth amplitudes and fifth phase angle values of the plurality of frequency point; a single frame of bone conduction noisy speech data can be converted from time domain to frequency domain, to obtain the sixth amplitudes and sixth phase angle values of the plurality of frequency point; based on the fifth amplitude and fifth phase angle value corresponding to the plurality of frequency points in the first frequency band, and the sixth amplitude and sixth phase angle value corresponding to the plurality of frequency points in the second frequency band, predicted input data is generated; the predicted input data is input into the speech fusion noise reduction network and performing prediction, to obtain the seventh amplitudes and seventh phase angle values of the plurality of frequency point; based on the seventh amplitudes and seventh phase angle values of the respective frequency points, frequency domain to time domain conversion can be performed, to obtain a single frame of predicted noise reduced speech data. Furthermore, in an embodiment, during the training of the speech fusion noise reduction network, the fifth amplitude of the plurality of frequency points in the first frequency band and the sixth amplitude of the plurality of frequency points in the second frequency band can be normalized and then spliced to obtain the first channel data; the fifth phase angle value of the plurality of frequency points in the first frequency band and the sixth phase angle value of the plurality of frequency points in the second frequency band can be normalized and then spliced to obtain the second channel data; and the first channel data and the second channel data are used as the target input data with two channels.

Further, based on the above-mentioned first and/or second embodiments, a third embodiment of the speech noise reduction method of the present disclosure is proposed.

In this embodiment, step S20 includes: Step S206, inputting the speech data in the first frequency band of the first speech data and the speech data in the second frequency band of the second speech data into the convolution layer of the speech fusion noise reduction network for convolution processing, to obtain convolution output data;

In this embodiment, the speech fusion noise reduction network includes a convolution layer, a recurrent neural network layer and an upsampling convolution layer. Among them, the convolution layer is configured to distinguish the noise and speech features of the input speech data within the spatial range, mainly configured to learn the distribution relationship between different frequency points, the recurrent neural network layer is mainly configured to perform associative memory of the input speech data within the time range, mainly retaining the information of the speech features in terms of time continuity, and the upsampling convolution layer is mainly configured to restore the input speech data within the spatial range, so as to output the better clean speech data of the same size as the input. The number and size of the convolution kernels in the convolution layer and the upsampling convolution layer can be set as needed, and are not limited in this embodiment. The recurrent neural network can be implemented by GRU (gated recurrent neural network), LSTM (Long Short-Term Memory), etc., which is not limited in this embodiment.

After obtaining the first speech data and the second speech data, the speech data in the first frequency band of the first speech data and the speech data in the second frequency band of the second speech data are first input into the convolution layer for convolution processing, and the processed data is called convolution output data for differentiation.

Step S207, inputting the convolution output data into the recurrent neural network layer of the speech fusion noise reduction network for processing, to obtain recurrent network output data.

The convolution output data is then input into the recurrent neural network layer for processing, and the processed data is called recurrent network output data for differentiation.

Step S208: inputting the convolution output data and the recurrent network output data into the upsampling convolution layer of the speech fusion noise reduction network for upsampling convolution processing, to obtain the target noise reduced speech data based on the result of the upsampling convolution processing.

The convolution output data and the training network output data are then input into the upsampling convolution layer for upsampling convolution processing, and the target noise reduced speech data can be obtained according to the processing result. In a specific embodiment, when the upsampling convolution layer is designed to output the amplitudes and phase angle values of the plurality of frequency point, the target noise reduced speech data can be obtained by converting frequency domain to time domain based on the amplitude and phase angle value of the plurality of frequency points. In other embodiments, when the upsampling convolution layer is designed to output data in other forms, the target noise reduced speech data can be obtained after corresponding calculation or conversion based on other forms of data.

Furthermore, in an embodiment, to reduce the network size of the speech fusion noise reduction network so that the speech fusion noise reduction network can be deployed on a product side with low computing resources, the speech fusion noise reduction network can be set as include 2 layers of convolution, 2 layers of GRU and 2 layers of upsampling convolution. Furthermore, in an embodiment, the speech fusion noise reduction network can be set as a network structure as shown in FIG. 3, wherein Relu is selected as the activation function of each network layer.

Further, based on the above-mentioned first, second and/or third embodiments, a fourth embodiment of the speech noise reduction method of the present disclosure is proposed. In this embodiment, before step S20, the method further includes:

Step S30, in a round of training, inputting the speech data in the first frequency band of the microphone noisy speech data and the speech data in the second frequency band of the bone conduction noisy speech data into the speech fusion noise reduction network to be trained, and performing prediction, to obtain predicted noise reduced speech data.

In this embodiment, the speech fusion noise reduction network can be subjected to multiple rounds of iterative training. In the first round of training, the initialized speech fusion noise reduction network is updated, and in subsequent rounds, of training the speech fusion noise reduction network is updated based on the speech fusion noise reduction network updated in the previous round of training.

In a round of training, the speech data in the first frequency band of the microphone noisy speech data and the speech data in the second frequency band of the bone conduction noisy speech data are input into the speech fusion noise reduction network to be trained and performing prediction, and the predicted speech data is called predicted noise reduced speech data for differentiation. The specific implementation of this step can refer to the specific implementation of step S20 in the first embodiment above, and will not be repeated here.

Step S40, calculating a first loss based on the speech data in the first frequency band of the predicted noise reduced speech data and the speech data in the first frequency band of the microphone clean speech data.

After the predicted noise reduced speech data is obtained, a loss (hereinafter referred to as the first loss for differentiation) may be calculated based on speech data in a first frequency band of the predicted noise reduced speech data and speech data in a first frequency band of the microphone clean speech data.

In a specific implementation, when the predicted noise reduced speech data is the amplitude and phase angle value of the plurality of frequency points, the microphone clean speech data can also be converted from time domain to frequency domain, to obtain the amplitude and phase angle value of the plurality of frequency points, and then the loss is calculated by comparing the amplitude of the plurality of frequency points in the first frequency band of the predicted noise reduced speech data with the amplitude of the plurality of frequency points in the first frequency band of the microphone clean speech data, and the loss is calculated by comparing the phase angle value of the plurality of frequency points in the first frequency band of the predicted noise reduced speech data with the phase angle value of the plurality of frequency points in the first frequency band of the microphone clean speech data. The two losses are collectively referred to as the first loss.

Step S50, calculating a second loss based on the speech data in the second frequency band of the predicted noise reduced speech data and the speech data in the second frequency band of the microphone clean speech data.

The loss (hereinafter referred to as the second loss for differentiation) may be calculated based on the speech data in the second frequency band of the predicted noise reduced speech data and the speech data in the second frequency band of the microphone clean speech data.

In a specific implementation, when the predicted noise reduced speech data is the amplitude and phase angle value of the plurality of frequency points, the microphone clean speech data can also be converted from time domain to frequency domain, to obtain the amplitude and phase angle value of the plurality of frequency points, and then the loss is calculated by comparing the amplitude of the plurality of frequency points in the second frequency band of the predicted noise reduced speech data with the amplitude of the plurality of frequency points in the second frequency band of the microphone clean speech data, and the loss is calculated by comparing the phase angle value of the plurality of frequency points in the second frequency band of the predicted noise reduced speech data with the phase angle value of the plurality of frequency points in the second frequency band of the microphone clean speech data. The two losses are collectively referred to as the second loss.

Step S60, performing the weighted summation on the first loss and the second loss to obtain a target loss, and updating the speech fusion noise reduction network to be trained according to the target loss, to use the updated speech fusion noise reduction network as the basis for the next round of training; and
after obtaining the first loss and the second loss, the first loss and the second loss may be weighted summed to obtain the target loss. Here, the weights may be set in advance as required, and are not limited in this embodiment. The speech fusion noise reduction network to be trained is updated according to the target loss, that is, the respective network parameters in the speech fusion noise reduction network are updated.

Step S70: After multiple rounds of training, the updated speech fusion noise reduction network is used as the trained speech fusion noise reduction network.

The speech fusion noise reduction network updated in the current round of training is used as the basis for the next round of training. After multiple iterated updating, the speech fusion noise reduction network updated in the last round is used as the trained speech fusion noise reduction network. The number of training rounds is not limited in this embodiment. For example, the training can be stopped after a certain number of rounds, or after a certain training time, or after the speech fusion noise reduction network converges.

In this embodiment, by calculating the target loss by weighted summation the speech data loss settings in the first frequency band and the second frequency band, the dominant role of the bone conduction noisy speech data in speech noise reduction during the training process of the speech fusion noise reduction network can be controlled, thereby enhancing the credibility of the low-frequency range of the bone conduction noisy speech data in the speech noise reduction process, and further improving the noise reduction effect of the speech fusion noise reduction network.

Further, in an embodiment, the step of performing the weighted summation of the first loss and the second loss, to obtain the target loss in step S60 includes:

Step S601, determining a round weight corresponding to a current round of training, wherein a larger number of training round corresponds to a larger weight corresponding to the second loss.

In this implementation, it is possible to set the weights corresponding to the first loss and the second loss to be dynamically adjusted during the training process.

Specifically, in a round of training, the weight corresponding to the current round of training can be determined (hereinafter referred to as the weight of the current round for differentiation). In this embodiment, there is no limitation on the method for determining the weight of the current round. For example, the current round of training can be substituted into a calculation formula for calculation or can be obtained from a look up table, but the weight determined according to the method conforms to the rule that the weight corresponding to the second loss is larger when the training round is larger. The purpose of such setting is to make the microphone noisy speech data dominate the training at the beginning of the training, so as to avoid the training direction of the speech fusion noise reduction network from going astray, and after the general direction of the training is determined to a certain extent, the bone conduction noisy speech data dominates the training, so that the speech fusion noise reduction network learns how to assist the microphone noisy speech data in speech noise reduction based on the bone conduction noisy speech data, thereby enhancing the credibility of the low-frequency range of the bone conduction noisy speech data in the speech noise reduction process, and then improving the noise reduction effect of the speech fusion noise reduction network.

Step S602: performing the weighted summation of the first loss and the second loss according to the weights of the current round to obtain a target loss.

After determining the weights of the current round, the first loss and the second loss are weighted summed using the weights of the current round to obtain the target loss.

Furthermore, in an embodiment, when the losses of the amplitudes and phase angle values in the microphone clean speech data and the predicted noise reduced speech data are calculated respectively, the losses calculated based on the amplitudes and phase angle values can be respectively weighted summed, and the weight corresponding to the amplitude can be greater than the weight corresponding to the phase angle value, so that while the speech fusion noise reduction network can focus on learning the speech information carried by the amplitude based on the frequency point to predict the noise reduced speech data, it can also learn the phase angle value based on the frequency point to predict the noise reduced speech data, so that the final predicted noise reduced speech data sounds more natural.

Furthermore, in an embodiment, it is assumed that the predicted noise reduced speech data predicted by the speech fusion noise reduction network includes the amplitudes and phase angle values of 120 frequency points, and the microphone clean speech data also includes the amplitudes and phase angle values of 120 frequency points, the loss calculated based on the amplitude can be expressed as:

$${L}_{amp} = \frac{1}{N} {\sum }_{i = 1}^{N} ( μ * {\sum }_{m = 0}^{6} \vert 1 / ( 1 + {e}^{- {preAmp}_{i}^{m}} ) - {cleanAmp}_{i}^{m} \vert + τ * {\sum }_{m = 7}^{119} \vert 1 / ( 1 + {e}^{- {preAmp}_{i}^{m}} ) - {cleanAmp}_{i}^{m} \vert )$$

Here, Lₐₘₚ is the loss function constructed by the amplitude of the frequency point, _{preAmp}_{ᵢ}^{m} is the amplitude of the m-th frequency point in the predicted noise reduced speech data, i represents the sample sequence number, _{cleanAmp}_{ᵢ}^{m} is the amplitude of the m-th frequency point in the clean speech data of the microphone; p represents the weight corresponding to the second frequency band, and T represents the weight corresponding to the first frequency band.

The loss calculated based on the phase angle value can be expressed as:

$${L}_{ang} = \frac{1}{N} {\sum }_{i = 1}^{N} ( μ * {\sum }_{m = 0}^{6} \vert 1 / ( 1 + {e}^{- {preAng}_{i}^{m}} ) - {cleanAng}_{i}^{m} \vert + τ * {\sum }_{m = 7}^{119} \vert 1 / ( 1 + {e}^{- {preAng}_{i}^{m}} ) - {cleanAng}_{i}^{m} \vert )$$

Here, L_{ang} is the loss function constructed by the phase angle value of the frequency point, _{preAng}_{ᵢ}^{m} is the phase angle value of the m-th frequency point in the predicted noise reduced speech data, i represents the sample sequence number, _{cleanAng}_{ᵢ}^{m} is the phase angle value of the m-th frequency point in the clean speech data of the microphone; μ represents the weight corresponding to the second frequency band, and τ represents the weight corresponding to the first frequency band.

The target loss can be expressed as:

$${L}_{total} = ( α * {L}_{amp} + β * {L}_{ang} )$$

Here, α represents the weight corresponding to the amplitude, and β represents the weight corresponding to the phase angle value.

The speech noise reduction scheme of the embodiment of the present disclosure can complete the real-time fusion processing of the bone conduction speech data frame and the single microphone speech data frame on the Bluetooth chip side, that is, by inputting the frequency amplitudes and phase angle values of the bone conduction speech data frame and the single microphone speech data frame into the speech fusion noise reduction network, the amplitudes and phase angle values of the frequency of the microphone clean speech data frame can be inferred through the speech fusion noise reduction network, and then the data of the sampling points of the microphone clean speech data frame can be output after complex number calculation and inverse Fourier transform. Based on the characteristics of bone conduction speech data, the embodiment of the present disclosure realizes the frequency fusion method of the bone conduction speech data frame and the single microphone speech data frame, and finely designs the structure of the speech fusion noise reduction network and its loss function, etc., which improves the real-time noise reduction performance of the Bluetooth chip side for bone conduction speech data and single microphone speech data to a certain extent.

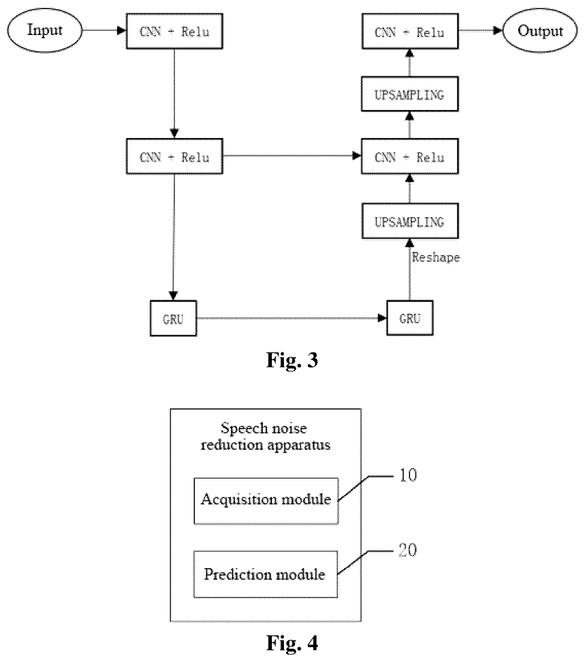

In addition, an embodiment of the present disclosure further provides a speech noise reduction apparatus. Referring to FIG. 4, the speech noise reduction apparatus includes:
an acquisition module 10 configured to acquire first speech data collected by a microphone and acquire second speech data collected by a bone conduction sensor;
a prediction module 20 configured to input the speech data in the first frequency band of the first speech data and the speech data in the second frequency band of the second speech data into a speech fusion noise reduction network and performing prediction, to obtain target noise reduced speech data,
wherein the first frequency band is higher than the second frequency band, the speech fusion noise reduction network is trained in advance by performing training using microphone noisy speech data and bone conduction noisy speech data as input data, and using microphone clean speech data corresponding to the microphone noisy speech data as a training label.

Furthermore, the prediction module 20 is also configured to:
convert the single-frame first speech data from time domain to frequency domain, to obtain first amplitudes and first phase angle values of the plurality of frequency point;
convert the single frame of second speech data from time domain to frequency domain, to obtain second amplitude values and second phase angle values of the plurality of frequency point;
generate target input data according to first amplitudes and first phase angle values corresponding to the plurality of frequency points in the first frequency band and second amplitudes and second phase angle values corresponding to the plurality of frequency points in the second frequency band;
input the target input data into the speech fusion noise reduction network and performing prediction, to obtain the third amplitudes and the third phase angle values of the plurality of frequency point;
based on the third amplitudes and the third phase angle values of the plurality of frequency point, perform frequency domain to time domain conversion, to obtain a single frame of the target noise reduced speech data.

Furthermore, the prediction module 20 is also configured to:
normalize the first amplitude of the plurality of frequency points in the first frequency band and the second amplitude of the plurality of frequency points in the second frequency band, respectively, and then splice them to obtain the first channel data;
normalize the first phase angle value of the plurality of frequency points in the first frequency band and the second phase angle value of the plurality of frequency points in the second frequency band, respectively, and then splice them to obtain second channel data; and
use the first channel data and the second channel data as target input data with two channels.

Furthermore, the prediction module 20 is also configured to:
input the speech data in the first frequency band of the first speech data and the speech data in the second frequency band of the second speech data into the convolution layer of the speech fusion noise reduction network for convolution processing, to obtain convolution output data;
input the convolution output data into the recurrent neural network layer of the speech fusion noise reduction network for processing to obtain the recurrent network output data; and
input the convolution output data and the recurrent network output data into the upsampling convolution layer of the speech fusion noise reduction network for upsampling convolution processing, to obtain the target noise reduced speech data based on the result of the upsampling convolution processing.

Furthermore, the speech noise reduction apparatus further includes:
a training module, wherein the training module is configured to:
in a round of training, input the speech data in the first frequency band of the microphone noisy speech data and the speech data in the second frequency band of the bone conduction noisy speech data into the speech fusion noise reduction network to be trained, and perform prediction to obtain predicted noise reduced speech data;
calculate a first loss based on the speech data in the first frequency band of the predicted noise reduced speech data and the speech data in the first frequency band of the microphone clean speech data;
calculate a second loss based on the speech data in the second frequency band of the predicted noise reduced speech data and the speech data in the second frequency band of the microphone clean speech data;
perform the weighted summation on the first loss and the second loss to obtain a target loss, and update the speech fusion noise reduction network to be trained according to the target loss, so that the updated speech fusion noise reduction network is used as the basis for the next round of training; and
after multiple rounds of training, use the updated speech fusion noise reduction network as the trained speech fusion noise reduction network.

Furthermore, the training module is also configured to:
determine a round weight corresponding to a current round of training, wherein a larger number of training round has a larger weight corresponding to the second loss; and
perform the weighted summation on the first loss and the second loss according to the weight of the current round to obtain the target loss.

Furthermore, the acquisition module 10 is also configured tor:
acquire first background noise data collected by the microphone in a background noise environment and first clean speech data collected by the microphone in a noise-isolated environment, and acquire second background noise data collected by a bone conduction sensor in the background noise environment and second clean speech data collected by the bone conduction sensor in the noise-isolated environment;
adding the first noise data to the first clean speech data according to a preset signal-to-noise ratio, to obtain microphone noisy speech data; and
adding the second noise data to the second clean speech data according to the noise weight in the microphone noisy speech data, to obtain the bone conduction noisy speech data.

The various embodiments of the speech noise reduction apparatus of the present disclosure can refer to the various embodiments of the speech noise reduction method of the present disclosure, and will not be described in detail here.

In addition, an embodiment of the present disclosure further proposes a computer-readable storage medium, on which a speech noise reduction program is stored. When the speech noise reduction program is executed by a processor, the following steps of the speech noise reduction method are implemented.

The various embodiments of the speech noise reduction device and the computer-readable storage medium of the present disclosure can all refer to the various embodiments of the speech noise reduction method of the present disclosure, and will not be repeated here.

It should be noted that, in this article, the terms “include”, “comprises” or any other variations thereof are intended to cover non-exclusive inclusion, so that a process, method, article or device including a series of elements includes not only those elements, but also other elements not explicitly listed, or also includes elements inherent to such process, method, article or device. If it is not specifically described, an element defined by the sentence “comprises a . . . ” does not exclude the existence of other identical elements in the process, method, article or device including the element.

The serial numbers of the above embodiments of the present disclosure are only for description and do not represent the advantages or disadvantages of the embodiments.

Through the description of the above implementation methods, those skilled in the art can clearly understand that the above-mentioned embodiment methods can be implemented by means of software plus a necessary general hardware platform, and of course can also be implemented by hardware, but in many cases the former is a better implementation method. Based on such an understanding, the technical solution of the present disclosure, or the part that contributes to the prior art, can be embodied in the form of a software product, which is stored in a storage medium (such as ROM/RAM, magnetic disk, optical disk), and includes a number of instructions for enabling a terminal device (which can be a mobile phone, computer, server, air conditioner, or network device, etc.) to execute the methods described in each embodiment of the present disclosure.

The above are only preferred embodiments of the present disclosure, and are not intended to limit the patent scope of the present disclosure. Any equivalent structure or equivalent process transformation made using the contents of the present disclosure specification and drawings, or directly or indirectly applied in other related technical fields, are also included in the patent protection scope of the present disclosure.

1. A speech noise reduction method, wherein the speech noise reduction method comprises:
acquiring first speech data collected by a microphone, and acquiring second speech data collected by a bone conduction sensor;
inputting speech data in a first frequency band of the first speech data and speech data in a second frequency band of the second speech data into a speech fusion noise reduction network and performing prediction, to obtain target noise reduced speech data,
wherein the first frequency band is higher than the second frequency band, the speech fusion noise reduction network is trained in advance by performing training using microphone noisy speech data and bone conduction noisy speech data as input data, and using microphone clean speech data corresponding to the microphone noisy speech data as a training label.

2. The speech noise reduction method according to claim 1, wherein the inputting the speech data in the first frequency band of the first speech data and the speech data in the second frequency band of the second speech data into the speech fusion noise reduction network and performing prediction, to obtain the target noise reduced speech data comprises:
converting the first speech data of a single frame from time domain to frequency domain, to obtain first amplitudes and first phase angles values of a plurality of frequency points; and
converting the second speech data of a single frame from time domain to frequency domain, to obtain second amplitudes and second phase angle values of a plurality of frequency points;
generating target input data according to the first amplitudes and the first phase angle values corresponding to the plurality of frequency points in the first frequency band and the second amplitudes and the second phase angle values corresponding to the plurality of frequency points in the second frequency band;
inputting the target input data into the speech fusion noise reduction network and performing prediction, to obtain third amplitudes and third phase angle values of a plurality of frequency points; and
performing frequency domain to time domain conversion based on the third amplitude and the third phase angle value of the plurality of frequency points, to obtain a single frame of the target noise reduced speech data.

3. The speech noise reduction method according to claim 2, wherein the generating target input data according to the first amplitudes and the first phase angle values corresponding to the plurality of frequency points in the first frequency band and the second amplitudes and the second phase angle values corresponding to the plurality of frequency points in the second frequency band comprises:
normalizing and then splicing the first amplitudes of the plurality of frequency points in the first frequency band and the second amplitudes of the plurality of frequency points in the second frequency band, respectively, to obtain first channel data;
normalizing and then splicing the first phase angle values of the plurality of frequency points in the first frequency band and the second phase angle values of the plurality of frequency points in the second frequency band, respectively, to obtain second channel data; and
using the first channel data and the second channel data as the target input data with two channels.

4. The speech noise reduction method according to claim 1, wherein the inputting the speech data in the first frequency band of the first speech data and the speech data in the second frequency band of the second speech data into the speech fusion noise reduction network and performing prediction, to obtain the target noise reduced speech data comprises:
inputting the speech data in the first frequency band of the first speech data and the speech data in the second frequency band of the second speech data into a convolution layer of the speech fusion noise reduction network for convolution processing, to obtain convolution output data;
inputting the convolution output data into a recurrent neural network layer of the speech fusion noise reduction network for processing, to obtain recurrent network output data; and
inputting the convolution output data and the recurrent network output data into an upsampling convolution layer of the speech fusion noise reduction network for upsampling convolution processing, to obtain the target noise reduced speech data based on a result of the upsampling convolution processing.

5. The speech noise reduction method according to claim 1, wherein before the inputting the speech data in the first frequency band of the first speech data and the speech data in the second frequency band of the second speech data into the speech fusion noise reduction network and performing prediction, to obtain the target noise reduced speech data, the method further comprises:
in a round of training, inputting the speech data in the first frequency band of the microphone noisy speech data and the speech data in the second frequency band of the bone conduction noisy speech data into the speech fusion noise reduction network to be trained, and performing prediction, to obtain predicted noise reduced speech data;
calculating a first loss based on the speech data in the first frequency band of the predicted noise reduced speech data and the speech data in the first frequency band of the microphone clean speech data;
calculating a second loss based on the speech data in the second frequency band of the predicted noise reduced speech data and the speech data in the second frequency band of the microphone clean speech data;
performing a weighted summation of the first loss and the second loss to obtain a target loss, and updating the speech fusion noise reduction network to be trained according to the target loss, to use the updated speech fusion noise reduction network as a basis for a next round of training; and
after multiple rounds of training, using the updated speech fusion noise reduction network as the trained speech fusion noise reduction network.

6. The speech noise reduction method according to claim 5, wherein the performing the weighted summation of the first loss and the second loss, to obtain the target loss comprises:
determining a weight corresponding to a current round of training, wherein a larger number of training round corresponds to a larger weight corresponding to the second loss; and
weighted summing the first loss and the second loss according to the round weight corresponding to the current round, to obtain the target loss.

7. The speech noise reduction method according to claim 1, wherein before the inputting the speech data in the first frequency band of the first speech data and the speech data in the second frequency band of the second speech data into the speech fusion noise reduction network and performing prediction, to obtain the target noise reduced speech data, the method further comprises:
acquiring first background noise data collected by the microphone in a background noise environment and first clean speech data collected by the microphone in a noise isolation environment, and acquiring second background noise data collected by the bone conduction sensor in the background noise environment and second clean speech data collected by the bone conduction sensor in the noise isolation environment;
adding the first noise data to the first clean speech data according to a preset signal-to-noise ratio, to obtain the microphone noisy speech data; and
adding the second noise data to the second clean speech data according to a noise weight in the microphone noisy speech data, to obtain the bone conduction noisy speech data.

8. A speech noise reduction apparatus, wherein the speech noise reduction apparatus comprises:
an acquisition module, configured to acquire first speech data collected by a microphone and second speech data collected by a bone conduction sensor;
a prediction module, configured to input speech data of first frequency band of the first speech data and speech data in the second frequency band of the second speech data into the speech fusion noise reduction network and performing prediction, to obtain target noise reduced speech data,
wherein the first frequency band is higher than the second frequency band, the speech fusion noise reduction network is trained in advance by performing training using microphone noisy speech data and bone conduction noisy speech data as input data, and using microphone clean speech data corresponding to the microphone noisy speech data as a training label.

9. A speech noise reduction device, wherein the speech noise reduction device comprises: a memory, a processor, and a speech noise reduction program stored in the memory and executable on the processor, wherein when executed by the processor, the speech noise reduction program implements steps of the speech noise reduction method according to claim 1.

10. A non-transitory computer-readable storage medium, wherein a speech noise reduction program is stored on the computer-readable storage medium, and when the speech noise reduction program is executed by a processor, steps of the speech noise reduction method according to claim 1 are implemented.
